(19) United States
(12) Patent Application Publication
(10) Pub. No.: US 2025/0311821 A1
(43) Pub. Date: Oct. 9, 2025

(54) Device with Quickly Adjustable Length and Trekking Pole with Quickly Adjustable Length

(71) Applicant: Ningbo Chaoyi Rehabilitation Technology Co., Ltd, Zhejiang (CN)

(72) Inventor: Shancong PAN, Zhejiang (CN)

(73) Assignee: Ningbo Chaoyi Rehabilitation Technology Co., Ltd, Zhejiang (CN)

(21) Appl. No.: 18/647,855

(22) Filed: Apr. 26, 2024

(30) Foreign Application Priority Data
Apr. 3, 2024 (CN) 2024206834400

(51) Int. Cl. A45B 9/02; A45B 9/00

(52) U.S. Cl. CPC A45B 9/02; A45B 2009/007; A45B 2200/05

(57) ABSTRACT

A device with a quickly adjustable length comprises an outer tube component and an inner tube component, wherein the inner tube component is slidably arranged in the outer tube component, the inner tube component comprises a connecting end, the connecting end is provided with an adjusting device, the inner tube component is provided with a transmission component, the adjusting device comprises a fixing component and an expansion component, the fixing component has a first end and a second end, the fixing component has an axial width gradually increasing from the first end to the second end, and the transmission component passes through the fixing component. The transmission component can drive the expansion component away from or close to the second end, so that the expansion component has a radially contracted and expanded state, thereby keeping the inner tube component and the outer tube component relatively sliding or locked.

### CROSS-REFERENCE TO RELATED APPLICATIONS

This application claims priority to China Patent Application 2024206834400 filed 3 Apr. 2024, the contents of which are hereby incorporated by reference in their entirety.

### TECHNICAL FIELD

The present invention relates to the technical field of climbing auxiliary instruments, and in particular to a device with a quickly adjustable length and a trekking pole with a quickly adjustable length.

### BACKGROUND

The trekking pole is a kind of auxiliary tool specially designed for mountaineering activities. The traditional trekking pole is difficult and inconvenient to operate when quickly adjusting its height.

U.S. Pat. No. 16,455,231 discloses a system and a method for adjusting length of a weight trekking pole, and specifically discloses that the length of the trekking pole is adjusted by a pin and a hole coupler, which is inconvenient to operate, and frequent insertion and removal of the pin may lead to hole wear, thus affecting the stability of connection and the overall durability of the trekking pole. In addition, the U.S. Pat. No. 13,691,812 discloses a telescopic member adjusting mechanism, which uses a mechanical interlocking system to adjust the service length of the trekking pole, increasing the complexity, and further making the construction, maintenance and repair of this equipment expensive.

Based on this, it is necessary to propose a new device, which is simple and convenient to operate when adjusting the length of the trekking pole.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

The present invention provides a device with a quickly adjustable length, which includes an outer tube component and an inner tube component, wherein the inner tube component is slidably arranged in the outer tube component, and the inner tube component comprises a connecting end, and the connecting end is provided with an adjusting device; and

the inner tube component is internally provided with a transmission component, and the adjusting device comprises a fixing component and an expansion component, wherein the fixing component has a first end and a second end, the fixing component has an axial width gradually increasing from the first end to the second end, the transmission component penetrates through the fixing component, and the transmission component can drive the expansion component away from or close to the second end, so that the expansion component has radially contracted and expanded state; and

wherein, when the expansion component is far away from the second end, the expansion component is in a contracted state, and the inner tube component can slide relative to the outer tube component; when the expansion component is close to and abutted against the second end, the expansion component is in an expanded state, and the outer tube component and the inner tube component are kept in a locked position.

The transmission component can drive the expansion component to move away from or close to the first part, wherein when the expansion component moves away from the first part, the expansion component is in a contracted state, and the outer tube component can slide relative to the inner tube component; when the expansion component moves close to the first part and abuts against the bottom end, the expansion component is in an expanded state, and the expansion component can keep the outer tube component and the inner tube component in a locked position.

The present invention provides a device with a quickly adjustable length, which includes an outer tube component and an inner tube component, wherein the inner tube component is slidably arranged in the outer tube component, and the inner tube component comprises a connecting end, and the connecting end is provided with an adjusting device; and

the inner tube component is internally provided with a transmission component, which comprises a transmission rod and a pressing component; the adjusting device comprises an expansion component and a fixing component; the fixing component has a first end and a second end; the fixing component has an axial width gradually increasing from the first end to the second end; the transmission rod penetrates through the fixing component; and the pressing component can drive the transmission rod to axially displace along the inner tube component, thereby driving the expansion component away from or close to the second end, so that the expansion component has radially contracted and expanded states; and

wherein, when the expansion component is far away from the second end, the expansion component is in a contracted state, and the inner tube component can slide relative to the outer tube component; when the expansion component is close to and abutted against the second end, the expansion component is in an expanded state, and the outer tube component and the inner tube component are kept in a locked position.

The present invention further provides a trekking pole with a quickly adjustable length, which includes a telescopic strut component and an adjusting device arranged in the strut component;

wherein a fixing component is also arranged in the strut component, and the fixing component has a first end and a second end, and the fixing component has an axial width gradually increasing from the first end to the second end; and

the adjusting device comprises a transmission component and an expansion component, wherein the transmission component comprises a transmission rod and a pressing component; the transmission rod penetrates through the fixing component; and the transmission rod can drive the expansion component away from or close to the second end, so that the expansion component has radially contracted and expanded states; and

when the expansion component is far away from the second end, the expansion component is in a contracted state, and the strut component is in an extended or contracted state; when the expansion component is close to and abutted against the second end, the expansion component is in an expanded state and keeps the strut component in a locked position.

### BRIEF DESCRIPTION OF DRAWINGS

In order to explain the technical solution of this application more clearly, the drawings needed in the implementation will be briefly introduced below. Obviously, the drawings described below are only some implementations of this application. For those skilled in the art, other drawings can be obtained according to these drawings without creative work.

FIG. 1 is a schematic view of the overall sectional structure of a device with a quickly adjustable length;

FIG. 2 is a schematic sectional view of the transmission component;

FIG. 3 is an enlarged structural schematic view of the support block;

FIG. 4 is a schematic structural view of the connection section between the expansion component and the fixing component;

FIG. 5 is a schematic structural diagram of the expansion component;

FIG. 6 is a schematic sectional view of the outer tube component;

FIG. 7 is a schematic diagram of the connection structure of the lower joint rod and the outer tube component;

FIG. 8 is a schematic sectional view of the connection between the lower joint rod and the outer tube component;

FIG. 9 is a schematic structural view of the protective sleeve and the tip part outside the outer tube component and the inner tube component;

FIG. 10 is a schematic structural view of the handle part;

FIG. 11 is a schematic structural diagram of a trekking pole with a rapidly adjustable length.

In the figures:

Device with a quickly adjusting length (100); Outer tube component (1000); Protective sleeve (1001); Inner tube component (2000); Connecting end (2001); Limit block (2002); Through hole (2201); Groove (2202); Limit member (2203); Protruding block (2204); Second elastic member (2003); Positioning block (2004); Positioning hole (2005); Lower joint rod (2006); Mounting hole (2007); Sheath (2008); Tip part (2009); Handle part (2010); Connecting shaft (2011); Adjusting device (3000); Transmission component (3001); Transmission rod (3101); Pressing component (3102); First elastic member (3103); Fixing block (3104); Pressing part (3105); Third elastic member (3106); Expansion component (3002); Connecting part (3201); Connecting hole (3202); Expansion part (3203); Elastic groove (3204); Expansion gap (3205); Reset ring (3206); Fixing component (3003); First end (3301); Second end (3302); Transmission channel (3303);

Trekking pole (110); Strut component (120); Adjusting device (130); Transmission component (131); Expansion component (132); Transmission rod (133); Pressing component (134); Fixing component (140); First end (141); Second end (142).

### DESCRIPTION OF EMBODIMENTS

In describing the preferred embodiments, specific terminology will be resorted to for the sake of clarity. It is to be understood that each specific term includes all technical equivalents which operate in a similar manner to accomplish a similar purpose.

While various aspects and features of certain embodiments have been summarized above, the following detailed description illustrates a few exemplary embodiments in further detail to enable one skilled in the art to practice such embodiments. Reference will now be made in detail to embodiments of the inventive concept, examples of which are illustrated in the accompanying drawings. The accompanying drawings are not necessarily drawn to scale. The described examples are provided for illustrative purposes and are not intended to limit the scope of the invention. It should be understood, however, that persons having ordinary skill in the art may practice the inventive concept without these specific details.

It will be understood that, although the terms first, second, etc. may be used herein to describe various elements, these elements should not be limited by these terms. These terms are only used to distinguish one element from another. For example, a first attachment could be termed a second attachment, and, similarly, a second attachment could be termed a first attachment, without departing from the scope of the inventive concept.

It will be understood that when an element or layer is referred to as being “on,” “coupled to,” or “connected to” another element or layer, it can be directly on, directly coupled to or directly connected to the other element or layer, or intervening elements or layers may be present. In contrast, when an element is referred to as being “directly on,” “directly coupled to,” or “directly connected to” another element or layer, there are no intervening elements or layers present. Like numbers refer to like elements throughout. As used herein, the term “and/or” includes any and all combinations of one or more of the associated listed items.

As used in the description of the inventive concept and the appended claims, the singular forms “a,” “an,” and “the” are intended to include the plural forms as well, unless the context clearly indicates other.

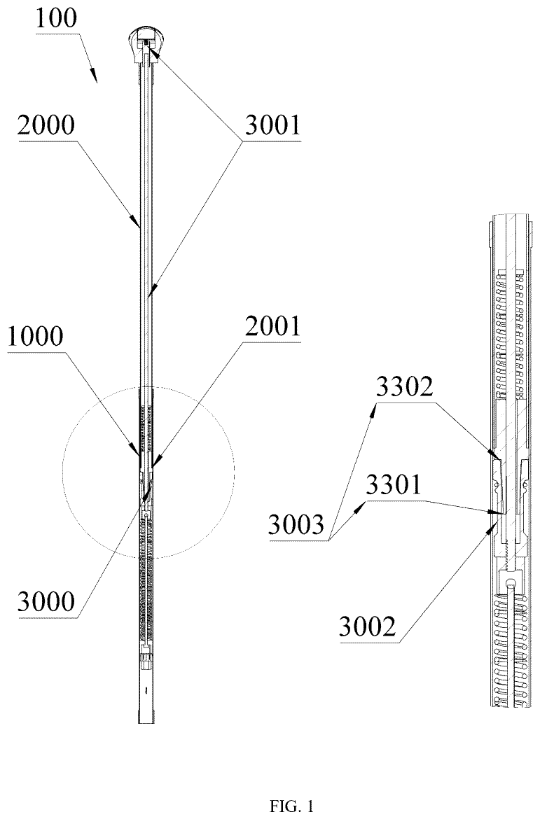

The present invention discloses a device with a quickly adjustable length 100, as shown in FIG. 1, including an outer tube component 1000 and an inner tube component 2000, wherein the inner tube component 2000 is slidably arranged in the outer tube component 1000, the inner tube component 2000 includes a connecting end 2001, the connecting end 2001 is provided with an adjusting device 3000, and the inner tube component 2000 is provided with a transmission component 3001. The adjusting device 3000 includes an expansion component 3002 and a fixing component 3003, wherein the fixing component 3003 has a first end 3301 and a second end 3302; the fixing component 3003 has an axial width gradually increasing from the first end 3301 to the second end 3302; the transmission component 3001 penetrates through the fixing component 3003; and the transmission component 3001 can drive the expansion component 3002 away from or close to the second end 3302. Therefore, the expansion component 3002 has radially contracted and expanded states. When the expansion component 3002 is far away from the second end 3302, the expansion component 3002 is in a contracted state, and the inner tube component 2000 can slide relative to the outer tube component 1000. When the expansion component 3002 is close to and abuts against the second end 3302, the expansion component 3002 is in an expanded state, and the outer tube component 1000 and the inner tube component 2000 are kept in a locked state. Through the matching use of the transmission component 3001 and the expansion component 3002, the user can quickly adjust the relative length between the outer tube component and the inner tube component, thus adapting to different use requirements.

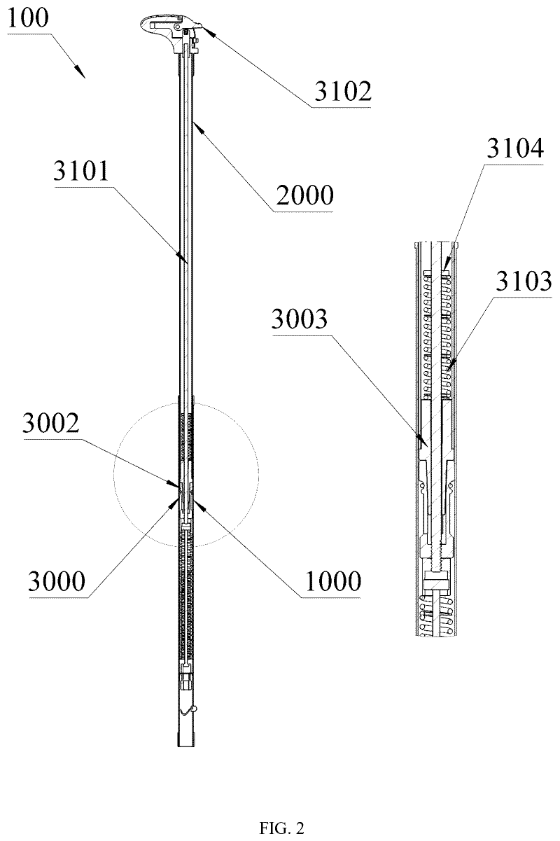

In this embodiment, as shown in FIG. 2, the transmission component 3001 includes a transmission rod 3101, and a pressing component 3102 connected to the top end of the transmission rod 3101; the pressing component 3102 can drive the transmission component 3001 to move axially along the inner tube component 2000. The transmission component 3001 also includes a first elastic member 3103 arranged inside the inner tube component 2000, and a fixing block 3104 is also arranged on the transmission rod 3101, and one end of the first elastic member 3103 abuts against the fixing block 3104. Through the top pressing component 3102, the user can drive the transmission component 3001 more easily, making the adjustment process more simple and intuitive. The first elastic member 3103 can also automatically reset the transmission component 3001 to the original state after canceling the pressing force, which is convenient for repeated use.

In other embodiments (not shown in the figure), a plurality of elastic member with different elastic coefficients are arranged inside the inner tube component 2000, thus providing different levels of resistance and restoring force, which is suitable for different working environments. In other embodiments (not shown in the figure), a position sensor or a pressure sensor is integrated in the transmission component to monitor and adjust the relative position between the inner tube component 2000 and the outer tube component 1000 or the state of the expansion component 3002 in real time. In other embodiments (not shown in the figure), a motor device is arranged in the inner tube component 2000, and manual pressing is replaced by the motor device, so that the operation is more convenient and automatic.

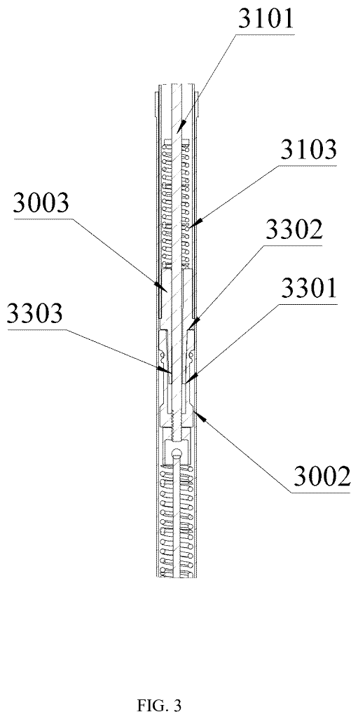

In this embodiment, as shown in FIG. 3, the other end of the first elastic member 3103 abuts against the fixing component 3003, and can elastically push the fixing component 3003. A transmission channel 3303 is arranged in the fixing component 3003, and the transmission rod 3101 penetrates through the transmission channel 3303 and extends outward to connect with the expansion component 3002. The transmission rod 3101 passes through the transmission channel 3303 and is connected with the expansion component 3002. This direct connection can reduce the energy loss and improve the transmission efficiency.

In other embodiments (not shown in the figure), the fixing component 3003 has a transmission channel 3303 with an adjustable diameter, so that it can adapt to transmission rods 3101 with different diameters, thereby improving the versatility and flexibility of the device.

In other embodiments (not shown in the figure), a damping system is added between the fixing component 3003 and the first elastic member 3103 to reduce vibration and improve stability, especially under the condition of high-speed movement or heavy load.

In other embodiments (not shown in the figure), a microprocessor and a sensor network are integrated in the inner tube component 2000 to monitor and adjust the position of the fixing component 3003 and the state of the expansion component 3002 in real time and realize automatic control.

In other embodiments (not shown in the figure), a thermal expansion compensation material is added to the fixing component 3003 or the transmission rod 3101 to automatically adjust the length to offset the influence of temperature change.

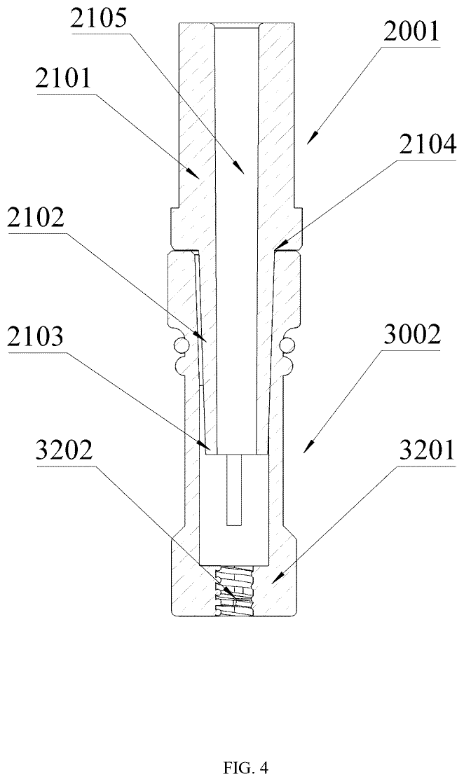

In this embodiment, as shown in FIG. 4, the expansion component 3002 includes a connecting part 3201, and the connecting part 3201 is provided with a connecting hole 3202, and the connecting hole 3202 is provided with an internal thread, and the bottom end part of the transmission rod 3101 is provided with an external thread, and the transmission rod 3101 is inserted into the connecting hole 3202 and extends downward, and is tightly connected by threads, so that the transmission rod 3101 and the expansion component 3002 are connected. Through the threaded fastening connection, the connection between the transmission rod 3101 and the expansion component 3002 is firmer, which reduces the possibility of loosening during use. If the transmission rod 3101 needs to be replaced or repaired, the threaded connection makes it easier to disassemble and reinstall.

In other embodiments (not shown in the figure), a spring locking mechanism is integrated in the connecting part 3201, and when the transmission rod 3101 is insert link-holed, it is automatically locked to prevent it from falling off in a vibration environment.

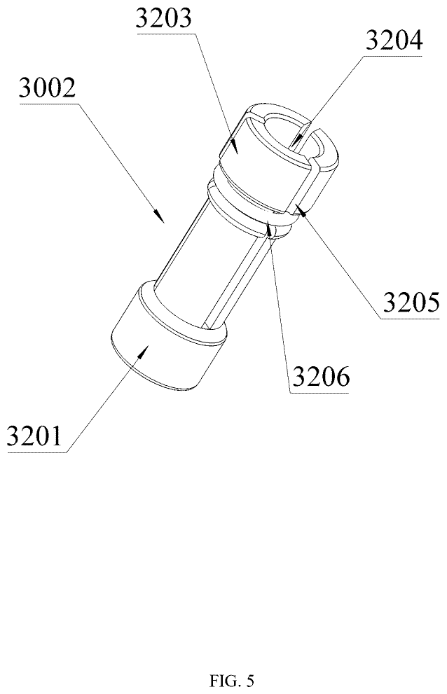

In this embodiment, as shown in FIGS. 4-5, the expansion component 3002 further includes an expansion part 3203 which defines an elastic groove 3204. When the elastic groove 3204 is configured to release the second end 3302, the expansion part 3203 contracts in the radial direction and releases the pressure exerted on the inner wall of the outer tube component 1000, thereby releasing the inner tube component 2000 and the outer tube component 1000, so that the inner tube component 2000 and the outer tube component 1000 can slide relatively. When the elastic groove 3204 is configured to receive the second end 3302, the expansion part 3203 expands in the radial direction and applies pressure to the inner wall of the outer tube component 1000, so that the inner tube component 2000 and the outer tube component 1000 are in a locked position, thus facilitating the adjustment of the length, simplifying the operation process, enabling the user to quickly adjust the length without complicated tools or steps, and improving the working efficiency.

In this embodiment, as shown in FIG. 5, the expansion part 3203 has a plurality of expansion gaps 3205, and the expansion gaps 3205 are favorable for the expansion part 3203 to contract or expand in the radial direction. A reset ring 3206 is arranged on the outer side of the expansion part 3203, and the reset ring 3206 is made of elastic material. The expansion gap 3205 enables the expansion part 3203 to contract or expand more easily in the radial direction, providing better elastic adjustment ability. The reset ring 3206 is made of elastic material, which can be quickly restored to the original state after the expansion part 3203 releases the second end 3302, thus improving the operation efficiency.

In other embodiments (not shown in the figure), a hydraulic system is provided in the expansion part 3203, and the hydraulic system can assist the expansion and contraction of the expansion part 3203 to provide greater strength and control accuracy.

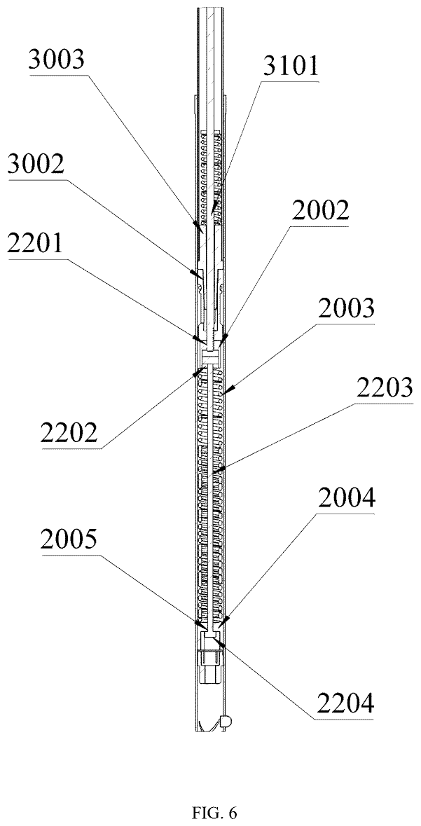

In this embodiment, as shown in FIG. 6, the outer tube component 1000 is also provided with a limit block 2002, the lower end of which abuts against a second elastic member 2003, and the limit block 2002 is provided with a through hole 2201 with an internal thread, and the transmission rod 3101 passes through the through hole 2201 and is firmly connected with the limit block 2002 through threaded connection, so that the transmission rod 3101 can drive the limit block 2002 to move longitudinally. The limit block 2002 is provided with a groove 2202, and a limit member 2203 is arranged in the groove 2202. The bottom of the limit member 2203 is provided with a protruding block 2204, and the lower end of the outer tube component 1000 is also provided with a positioning block 2004 with a positioning hole 2005. The limit member 2203 passes through the positioning hole 2005 and is fixed by the protruding block 2204, and the lower end of the second elastic component 2003 abuts against the upper end of the positioning block 2004. The limit block 2002 penetrates through the through hole 2201 and is connected with the transmission rod 3101 by screw thread, which can realize accurate longitudinal movement, thus providing better position control. The second elastic member 2003 provides stable elastic support for the limit block 2002, which reduces the influence of vibration and impact on the positioning accuracy.

In other embodiments (not shown in the figure), a self-locking mechanism is added in the groove 2202 to automatically lock the limit member 2203 when it reaches the preset position to prevent it from moving due to vibration or misoperation.

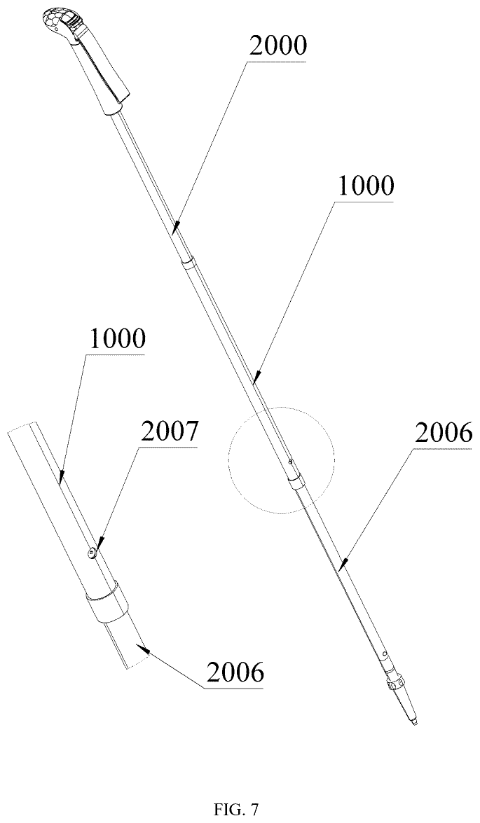

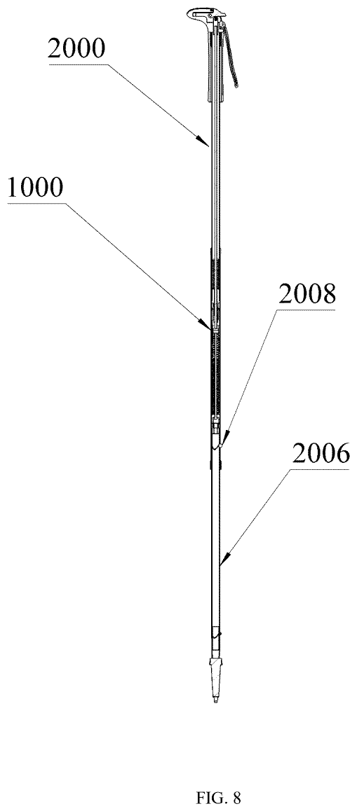

In this embodiment, as shown in FIGS. 7-8, the lower end of the outer tube component 1000 is also connected with a lower joint rod 2006, wherein the lower joint rod 2006 can slide relative to the outer tube component 1000, and at least one mounting hole 2007 is respectively arranged on the lower joint rod 2006 and the outer tube component 1000. The inner part of the lower joint rod 2006 includes at least one sheath 2008. When the sheath 2008 passes through the mounting hole 2007, the lower joint rod 2006 and the outer tube component 1000 are in the locked position. When the sheath 2008 is released, the lower joint rod 2006 and the outer tube component 1000 can slide relatively to adjust the use length. The lower joint rod 2006 can slide relative to the outer tube component 1000, which provides flexibility in adjusting length and adapts to different use scenarios. Through the cooperation between the mounting hole 2007 and the sheath 2008, the user can quickly adjust and fix the position of the lower joint rod 2006 through the insertion and release of the sheath 2008, and the operation is simple.

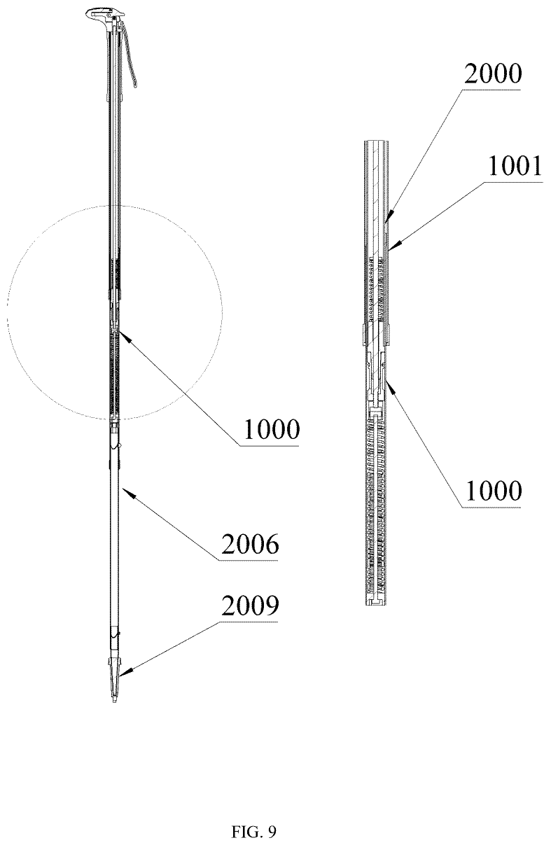

In other embodiments (not shown in the figure), a quick release button is provided in the outer tube component 1000 to quickly release the sheath 2008, so that the lower joint rod 2006 can be quickly adjusted or disassembled. In other embodiments (not shown in the figure), a scale or a length mark is marked on the lower joint rod 2006, which is convenient for the user to quickly find the required length position and ensures the repetition accuracy. In this embodiment, as shown in FIG. 9, the outer tube component 1000 and the

inner tube component 2000 are provided with protective sleeves 1001, and the bottom of the lower joint rod 2006 is provided with a tip part 2009. The protective sleeve 1001 can protect the inner and outer pipe components from the external environment, such as dust prevention, water prevention or mechanical damage, and prolong the service life of the device. The tip part 2009 makes it easier for the lower joint rod 2006 to be inserted into the ground or other media, which is suitable for application scenarios where the position of the device needs to be fixed.

In other embodiments (not shown in the figure), the tip part 2009 has a detachable structure, which enables users to adjust or replace it according to different use requirements.

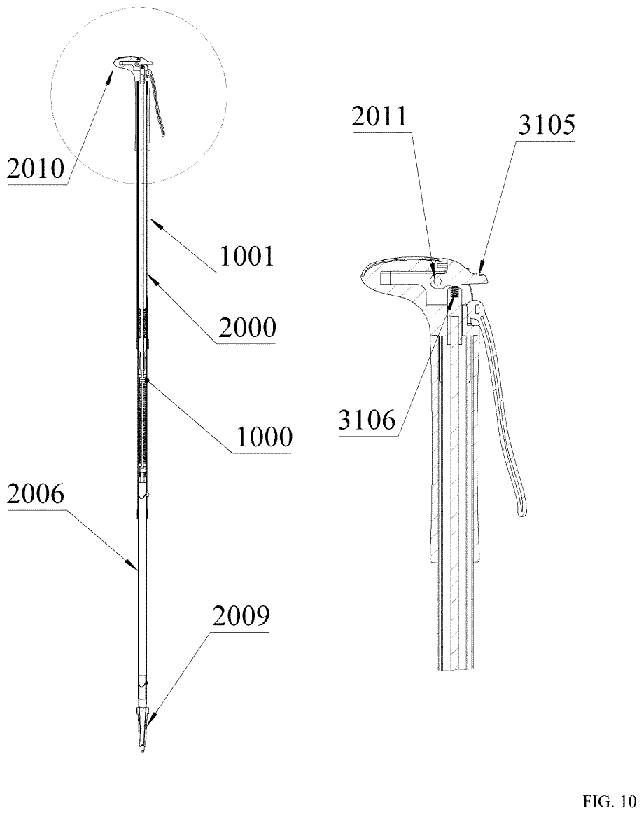

In this embodiment, as shown in FIG. 10, a handle part 2010 is connected to the top end of the inner tube component 2000, and the pressing component 3102 is connected to the front surface of the handle part 2010 through a connecting shaft 2011, and the pressing component 3102 includes a pressing part 3105 which can move axially around the connecting shaft 2011. The pressing component 3102 also includes a third elastic member 3106. When the pressing part 3105 is pressed downward, the pressing part 3105 elastically pushes against the third elastic member 3106 to drive the transmission component 3001 to move longitudinally. The pressing component 3102 allows the user to control the transmission component 3001 through intuitive pressing action, so as to adjust the length of the inner tube component 2000. The third elastic member 3106 provides elastic feedback. When the pressure is no longer applied, it can push the pressing part 3105 back to its original position, which is convenient for continuous operation.

In other embodiments (not shown in the figure), a vibration feedback mechanism is added to the pressing part 3105 to provide a vibration prompt when it reaches a preset position or strength, so as to enhance the user's operation perception. In other embodiments (not shown in the figure), an integrated electronic control system is provided in the pressing part 3105, and the movement of the pressing component 3102 is controlled by buttons or a touch screen to realize automatic control.

In this embodiment, the expansion component 3002 is made of an elastic material. Elastic materials can usually withstand repeated deformation without damage, and the expansion component can still maintain its function after repeated use. Secondly, the elastic material can be deformed when it is subjected to external force, and it will be restored to its original state after the external force is removed, which provides good flexibility and adaptability for the expansion component. In addition, elastic materials often have good temperature resistance and chemical stability, which makes the expansion component work under various environmental conditions without degradation due to the influence of temperature or chemical substances.

In other embodiments (not shown), the surface of the expansion component 3002 is coated with a layer of wear-resistant material. This can improve the durability and long-term stability of the component, especially in the environment of frequent friction or high load.

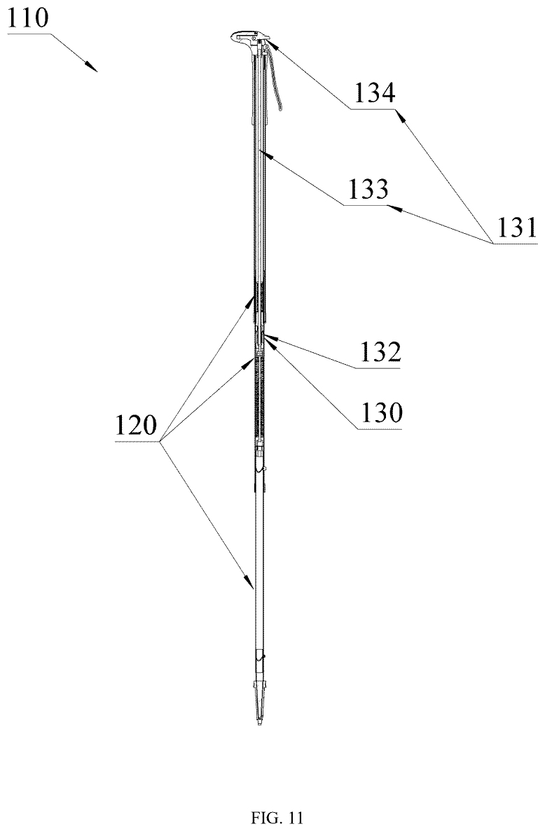

The present invention also provides a fast adjustable trekking pole 110, as shown in FIG. 11, which includes a telescopic strut component 120 and an adjusting device 130 arranged in the strut component for quickly adjusting the length; the strut component 120 is provided with a fixing component 140 with a first end 141 and a second end 142, and the fixing component 140 has an axial width gradually increasing from the first end 141 to the second end 142. The adjusting device 130 includes a transmission component 131 and an expansion component 132, wherein the transmission component 131 includes a transmission rod 133 and a pressing component 134, and the transmission rod 133 penetrates through the fixing component 140. The transmission rod 133 can drive the expansion component 132 away from or close to the second end 142, so that the expansion component 132 has radially contracted and expanded states. When the expansion component 132 is far away from the second end 142, the expansion component 132 is in a contracted state, and the strut component 120 is in an extended or contracted state. When the expansion component 132 is close to and abuts against the second end 142, the expansion component 132 is in an expanded state.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

The invention has now been described in detail for the purposes of clarity and understanding. However, those skilled in the art will appreciate that certain changes and modifications may be practiced within the scope of the appended claims.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

What is claimed is:

1. A device with a quickly adjustable length, comprising an outer tube component and an inner tube component, wherein said inner tube component is slidably arranged in said outer tube component, and said inner tube component comprises a connecting end, and said connecting end is provided with an adjusting device; and
said inner tube component is internally provided with a transmission component, and said adjusting device comprises a fixing component and an expansion component, wherein said fixing component has a first end and a second end, said fixing component has an axial width gradually increasing from said first end to said second end, said transmission component penetrates through said fixing component, and said transmission component can drive said expansion component away from or close to said second end, so that said expansion component has radially contracted and expanded state; and
wherein, when said expansion component is far away from said second end, said expansion component is in a contracted state, and said inner tube component can slide relative to said outer tube component; and when said expansion component is close to and abutted against said second end, said expansion component is in an expanded state, and said outer tube component and said inner tube component are kept in a locked position.

2. The device with a quickly adjustable length according to claim 1, wherein said transmission component comprises a transmission rod and a pressing component connected to a top end of said transmission rod, said pressing component can drive said transmission component to move axially along said inner tube component; and said transmission component further comprises a first elastic member arranged inside said inner tube component, and a fixing block is also arranged on said transmission rod, and one end of said first elastic member abuts against said fixing block.

3. The device with a quickly adjustable length according to claim 2, wherein the other end of said first elastic member abuts against said fixing component and can elastically push said fixing component; and a transmission channel is arranged in said fixing component, and said transmission rod penetrates through said transmission channel and extends downwards to be connected with said expansion component.

4. The device with a quickly adjustable length according to claim 3, wherein said expansion component comprises a connecting part, and a connecting hole is formed in said connecting part, and said transmission rod is inserted into said connecting hole and is connected by a thread, so that said transmission rod and said expansion component are connected.

5. The device with a quickly adjustable length according to claim 4, wherein said expansion component further comprises an expansion part which defines an elastic groove, and when said elastic groove is configured to release said second end, said expansion part contracts in a radial direction and releases a pressure exerted on inner wall of said outer tube component, thereby releasing an inner tube component and said outer tube component, so that said inner tube component and said outer tube component can slide relatively; and when said elastic groove is configured to abut against said second end, said expansion part expands in a radial direction and applies a pressure to inner wall of said outer tube component, so that said inner tube component and said outer tube component are in a locked position.

6. The device with a quickly adjustable length according to claim 5, wherein said expansion part has a plurality of expansion gaps, which are beneficial to radial contraction or expansion of said expansion part, and a reset ring is arranged on outer side of said expansion part, and said reset ring is made of an elastic material.

7. The device with a quickly adjustable length according to claim 6, wherein a limit block is further arranged in said outer tube component, and a lower end of said limit block abuts against a second elastic member.

8. The device with a quickly adjustable length according to claim 7, wherein said limit block is provided with a through hole, and said transmission rod passes through said through hole and is firmly connected with said limit block through threaded connection, so that said transmission rod can drive said limit block to move longitudinally.

9. The device with a quickly adjustable length according to claim 8, wherein a groove is arranged on said limit block, a limit member is arranged in said groove, and a protruding block is arranged at a bottom of said limit member.

10. The device with a quickly adjustable length according to claim 9, wherein a lower end of said outer tube component is further provided with a positioning block, and said positioning block is provided with a positioning hole, and said limit member is inserted in said positioning hole and fixed by the protruding block, and a lower end of said second elastic member abuts against an upper end of said positioning block.

11. The device with a quickly adjustable length according to claim 10, wherein the lower end of said outer tube component is also connected with a lower joint rod, wherein said lower joint rod can slide relative to said outer tube component.

12. The device with a quickly adjustable length according to claim 11, wherein at least one mounting hole is respectively arranged on said lower joint rod and said inner tube component, and said lower joint rod comprises at least one sheath inside; and when said sheath penetrates said mounting hole, said lower joint rod and said outer tube component are in a locked position, and when said sheath is released, said lower joint rod and said outer tube component can slide relatively to adjust a use length.

13. The device with a quickly adjustable length according to claim 12, wherein protective sleeves are arranged at outer sides of said outer tube component and said inner tube component, and a tip part is arranged at a bottom of said lower joint rod.

14. The device with a quickly adjustable length according to claim 13, wherein a handle part is connected to a top end of said inner tube component, and said pressing component is connected to a front surface of said handle part through a connecting shaft, and comprises a pressing part which can move axially around said connecting shaft.

15. The device with a quickly adjustable length according to claim 14, wherein said pressing component further comprises a third elastic member, and when said pressing part is pressed downwards, said pressing component elastically pushes against said third elastic member to drive said transmission component to move longitudinally.

16. A device with a quickly adjustable length, comprising an outer tube component and an inner tube component, wherein said inner tube component is slidably arranged in said outer tube component, and said inner tube component comprises a connecting end, and said connecting end is provided with an adjusting device; and
said inner tube component is internally provided with a transmission component, which comprises a transmission rod and a pressing component; and said adjusting device comprises an expansion component and a fixing component; and said fixing component has a first end and a second end; and said fixing component has an axial width gradually increasing from said first end to said second end; and said transmission rod penetrates through said fixing component; and said pressing component can drive said transmission rod to axially displace along said inner tube component, thereby driving said expansion component away from or close to said second end, so that said expansion component has radially contracted and expanded states; and
wherein, when said expansion component is far away from said second end, said expansion component is in a contracted state, and said inner tube component can slide relative to said outer tube component; and when said expansion component is close to and abutted against said second end, said expansion component is in an expanded state, and said outer tube component and said inner tube component are kept in a locked position.

17. The device with a quickly adjustable length according to claim 16, wherein said expansion component is made of an elastic material.

18. The device with a quickly adjustable length according to claim 17, wherein a handle part is connected to a top end of said inner tube component, and said pressing component is connected to a front surface of said handle part through a connecting shaft, and comprises a pressing part which can move axially around said connecting shaft.

19. The device with a quickly adjustable length according to claim 18, wherein said pressing component further comprises a third elastic member, and when said pressing part is pressed downwards, said pressing part elastically pushes against said third elastic member, thereby driving said transmission component to move longitudinally.

20. A trekking pole with a quickly adjustable length, comprising a telescopic strut component and an adjusting device arranged in said strut component; and
wherein a fixing component is also arranged in said strut component, and said fixing component has a first end and a second end, and said fixing component has an axial width gradually increasing from said first end to said second end; and
said adjusting device comprises a transmission component and an expansion component, wherein said transmission component comprises a transmission rod and a pressing component; and said transmission rod penetrates through said fixing component; and said transmission rod can drive said expansion component away from or close to said second end, so that said expansion component has radially contracted and expanded states; and
when said expansion component is far away from said second end, said expansion component is in a contracted state, and said strut component is in an extended or contracted state; and when said expansion component is close to and abutted against said second end, said expansion component is in an expanded state and keeps said strut component in a locked position.
